(19) United States
(12) Patent Application Publication
(10) Pub. No.: US 2023/0365762 A1
(43) Pub. Date: Nov. 16, 2023

(54) ADDITIVE BASED ON MICRO AND NANO PARTICLES OF ZINC, SILVER AND COPPER METAL, USEFUL FOR IMPARTING VIRICIDAL ACTIVITY TO A POLYMER MATRIX

(71) Applicants: MARZULLO S.A., Santiago (CL); TOPCOPPER S.A., Santiago (CL)

(72) Inventors: Enzo Enrique Alberto Marzullo Varela, Santiago (CL); Carla Francisca Marzullo Varela, Chiguayante (CL)

(21) Appl. No.: 18/246,647

(22) PCT Filed: Sep. 24, 2021
(86) PCT No.: PCT/CL2021/050091

§ 371 Date: Mar. 24, 2023

Related U.S. Application Data
(60) Provisional application No. 63/082,898, filed on Sep. 24, 2020.

(51) Int. Cl. C08J 3/22; C08K 3/08

(52) U.S. Cl. CPC C08J 3/22; C08K 3/08; C08K 2003/085; C08K 2003/0893; C08K 2003/0806; C08K 2201/005; C08J 2323/06; C08J 2367/03

(57) ABSTRACT

Provided is an additive based on micro and nano particles of zinc, silver and copper metal for preparing a polymer material with antiviral and virucidal properties. The material is used to form or produce surfaces, containers of all types, garments, safety equipment, fabrics, paints, coatings or other items and reduces the growth or presence of respiratory viruses.

### FIELD OF THE INVENTION

The present invention pertains to the field of methods for the prevention of acute respiratory syndromes caused by viruses in humans and animals. Particularly, the present invention relates to a masterbatch composed of polymeric material and a metallic element such as copper, which has virucidal properties. Also provided is a polymeric material with antiviral and virucidal properties made by the disclosed masterbatch, and the use of such a material in the preparation of a product with the same properties.

### BACKGROUND OF THE INVENTION

Viruses are the smaller infectious agents that are currently known, are intracellular parasites, as they must enter a cell to be able to multiply where the host cell is then mutated (Delgado et al. 2015k). There are various types of viruses, within these we can find viruses that cause respiratory diseases.

Respiratory diseases caused by viruses are one of the major causes of morbidity and mortality in humans (Rijsbergen et al, 202′). often, these diseases are more severe in risk patients as immunodepressed, lactating and elderly (Rijsbergen et al, 202′). Respiratory viruses include human rhinovirus (HRV), influenza A virus and B (IAV and IBV), human respiratory syncytial virus (HRSV), human methanolmovirus (HMPV), human coronavirus (HCoV), human parainfluenza virus (HPIV), and human adenovirus (HAdV) (Rij sbergen et al, 202k).

In the year 2019 a pneumonia emergence was presented in the China city of Wuhan, which was expanded by the territory very quickly, at the time this pneumonia was classified as pandemia (Diaz-Castrillón et al, 2020′). the causative virus of this pneumonia was determined to correspond to a coronavirus and which caused an acute respiratory infection, which was referred to as COVID-19 (English disease-2019). Many coronavirus are causative of disease in domestic animals, and are therefore primarily of veterinary interest (Diaz-Castrillon et al. 2020).

COVID-19 disease has caused the date (September 2021) 4.55 million deaths and 219 million cases reported around the world (Johns Hopkins Medicine University, 2020).

COVID-19 pandemic has shown that treatment and prophylaxis options of this type of diseases are limited. In the case of some viruses, such as influenza, rhinovirus and SARS-CoV-2 exist available vaccines, but the efficacy as coverage is suboptimal and antiviral drugs typically have limited efficacy (Rijsbergen et al, 2021). It is, therefore, necessary to have another type of sanitary measures, such as social distance, hand washing, use of masks to prevent the propagation of these viruses, etc. (MINSAL, 2021).

Another important strategy in decreasing the propagation of this type of virus is surface sanitization. With COVID-19 pandemic have emerged different sanitizing products, among disinfecting aerosols, detergents, wipes embedded with surface cleaning agents (alcohol, ammonium, chlorides), metal particles containing products such as copper, among others (MINSAL, 2020).

Various documents and publications describe the virucidal properties of copper compounds alone and in conjunction with polymer matrices. Palza et al. 2015 for example, discloses that the addition of metallic particles such as copper or silver in polymer matrices allows for the production of new antimicrobial materials. They describe the preparation of materials by mixing polymeric material (polypropylene) and metal particles (nano-copper), where the release of metal ions was used to obtain critical information from the antimicrobial processes. They indicate that the size of the particles of the materials presents directly with its antimicrobial properties.

A study performed by Fujimori and collaborators at 2012 evaluated the antiviral activity of nanometer (I) iodide nanometric particles (Cul). These particles demonstrated aqueous stability and the generation of hydroxyl radicals, which are likely derived from monovalent copper (Cu+). The authors confirmed that Cul particles exhibited antiviral activity against porcine origin A influenza A virus (H1N1, 2009k) by plate titration.

The scientific document of Grass et al. in 2011 describes the characteristics of the metal copper as an antimicrobial agent on surfaces, presenting antimicrobial activity assays and metal copper toxicity on surface materials with respect to the use of ionic copper. Noyce et al. in 2007 evaluated the effect of copper and steel on influenza virus a, resulting in the count of virus particles incubated in a given time period exposed to copper were 500, while viral particles in steel corresponded to 500000.

A composition corresponding to a nasal aerosol for the prevention and treatment of SARS-associated viruses is disclosed in WO2005074990A2. This composition comprises a mucoadhesive polymer and a metal compound, where the latter may correspond to metallic copper.

WO2007091037A2 refers to a composition for the treatment of influenza virus, strains H1N1, H7N7, H9N2 or H5N1, preferably from the H5N1 strain causing the symptoms of the common cold. The composition comprises a metal (copper or copper ions), an aqueous agent (aloe vera gel), an acid compound and water.

EP1991209A2 describes the use of nanoparticles for virus reduction and/or propagation. These nanoparticles are primarily used for safety clothes making such as masks. The composition of these nanoparticles includes copper, copper oxide and/or copper phosphate. EP2786760A1 describes the use of metal particles for the manufacture of fibers, patterned articles, films, sheets, among others. It is noted that for the manufacture of these materials, monovalent copper compounds such as copper chloride, copper bromide, copper oxide, copper peroxide or copper thiocyanate are used and that are added by their antiviral characteristics.

Various other documents also describe the conformation of master batches composed of polymers and different copper species.

For example, CL201600965 discloses a polymeric material that prevents and/or reduces the formation of biofilms on the surface and which is useful for making medical materials comprising a base material of the polyvinylchloride type, polyethylene, polypropylene or nylon, which is incorporated between 0, 5-5% by mass of nanoparticles of nanostructures of the coreshell, where the copper nanoparticles are coated with silver.

In CN109401022 a low bacterial density polyethylene material composed of 65-70% by weight aniline of the 2-methoxy-N-acetyl acetyl group and 30-35% by weight of zinc or copper oxide is presented. CN110408179A has a masterbatch of polyethylene terephthalate in connection with copper, dispersing agents and antioxidants. CN107033556 provides a masterbatch type of copper (masterbatch), characterized in that it includes polyethylene terephthalate 75-96% and Nanocopper 4-25%.

In U.S. Pat. No. 9,913,476B2 there is disclosed or master batch containing high concentrations of antimicrobial materials such as copper salts, particularly copper iodide. These masterbatch compositions are added to other materials that are used to form various articles manufactured with antimicrobial properties, masterbatch functionalized particles or salts may be incorporated into porous particles prior to masterbatch formation

The proposals described heretofore are directed to generating materials and/or master batches incorporating copper, but from which its effective antiviral and virucidal effect has not been specifically demonstrated on respiratory viruses, specifically over COVID-19 and influenza.

### DETAILED DESCRIPTION OF THE INVENTION

The present invention relates to a masterbatch or antiviral and virucidal batch composed of:
(i) a polymeric material selected from low density polyethylene (PE), high density polyethylene (HDPE), linear low density polyethylene (LLDPE), polypropylene (PP), polyethylene terephthalate (PET), copolyester 5011 (modified PET or PETG) polycarbonate (PC), polymethylmethacrylate (PMMA), starch mixtures, polytrimethylene terephthalate (PTT), vinyl polychloride (PVC), polystyrene (PS), polybutylene terephthalate (PBAT), polycaprolactone (PCL) and polylactic acid (PLA), at a concentration of 65 and 98.5% w/w until 100% of the mixture is completed.
(ii) metallic copper particles at 1 to 25% w/w, wherein said particles exhibit a purity of 99.98 to 100%, without presenting oxygen or sulfides in their composition and present a size of 0.1 to 100 microns.
(iii) Additives such as glycerol monostearate, glycerol ester, sorbitol ester, alcaloxylated ester, oleochemical derivatives, amines and their derivatives, wherein the amines are selected from ethoxylated amines, ethoxylated alkyl amines (C13 to C15 ethoxylated alkyl amine), at concentrations of 0, 5 and 10% w/w of the total master batch.

This masterbatch or masterbatch may in turn be used to form polymeric materials having antiviral and virucidal activity. This material is made from the masterbatch and may be in the form of pellets, yarns, plates, blades, sheets, or other. These materials produced with the masterbatch can be used to form or make surfaces, containers of all types, garments, safety implements, fabrics, paints and coatings or others.

The base of the invention is the creation of a material that allows said surface to be maintained and contacting it free of contaminating agents such as bacteria, fungi and viruses. The present invention is particularly for the elimination of virus from the surfaces, particularly respiratory viruses. Particularly, the master batch and polymeric material serve to decrease the growth or presence of respiratory viruses (low viral load), in particular human influenza viruses and SARS-COV2.

To date, the biocidal antimicrobial mechanism of copper incorporated into different materials is known to be incorporated into different materials. Copper materials release ions in the presence of water and oxygen, the polarity of these materials allows complexing with components of the bacterial walls. For the case of virucidal activity, the amine additive described in this invention allows to increase the polarity of the polymeric matrix, which facilitates the release of metal copper species. Thus, when a virus is housed in one of these surfaces or materials with amines and copper, ions that react with moisture and oxygen are released, producing reactive oxygen species (ROS). Copper and ROS ions weaken the outer membrane of the viral particles by destroying them, including destruction of the DNA or viral RNA.

Unlike copper-containing materials with already known antimicrobial activity, the present invention provides antiviral, particularly virucidal characteristics, by enlarging the availability of materials exhibiting this type of characteristics, reducing the contact of virus contact with contaminated surfaces. Particularly in this invention, the virucidal activity of this material against respiratory viruses is presented.

The virucidal activity of this material is presented against viruses that affect the human respiratory tract, where such viruses may belong to the Paramba xovy family ri dae Adenoviral Orthomyxoviridae families. Such viruses include the respiratory respiratory virus (VRS), adenovirus (ADV), human metapneumovirus (hMPV), Influenza an and B, Parainfluenza, Rhinovirus, MERS, SARS (including SARS-COV-2 virus) and Coronavirus, without being limited to other types of viruses.

The present invention describes a material with virucidal activity comprising between 1 and 25% metallic copper, between 0.5 and 10% additives, amines, or a mixture of both and polymeric material which is added between 65 and 98.5% until 100% of the mixture is completed.

The development proposed in this invention comprises a process for the preparation of a virucidal polymeric material, comprising preparing a matrix of a polymer, which may be selected from the group of polyethylene (PE), low density polyethylene (LDPE), high density polyethylene (HDPE), linear low density polyethylene (LLDPE), polypropylene (PP), polyethylene terephthalate (PET), copolyester 5011 (modified PET or PETG) polycarbonate (PC) and polymethylmethacrylate (PMMA), starch mixtures, polytrimethylene terephthalate (PTT), vinyl polychloride (PVC), polystyrene (PS), polybutylene terephthalate (PBAT) terephthalate, polycaprolactone (PCL), and polylactic acid (PLA). The use of these materials may include, but are not limited to, use in other materials such as other polymers and compostable and biodegradable materials. To the preparation of the matrix or polymeric material, micro or nanoparticles of metallic copper are added.

The metallic copper particles (Cu) for the present invention have a purity of 99.98 to 100%, without presenting oxygen or sulfides in its composition. The particles used in the present invention have a size of 0.1 to 100 microns, particularly the size ranges from 0.3 to 40 microns, where the mean size is 15 microns.

Such a material may be made of any synthetic material that allows the introduction of the micro and/or nanoparticles of metallic copper and that impart additional advantageous characteristics to the virucidal material as antistatic, anti-condensantes, antifog or antivail, detergents and/or anti-friction, without being limited to another type of materials that can be used for this purpose. These materials can be selected, without being limited to the use of other compounds, of the group selected from ethoxylated amines, ethoxylated alkyl amines (ethoxylated C13 to C15 alkyl amine), glycerol monostearate, glycerol ester, sorbitol ester, alcaloxylated ester, oleochemical derivatives. Such materials used as additives can be individually incorporated, two or more, three or more, as solid additives or aqueous dispersion additives, all dependent on the requirements of the material to be performed. In the masterbatch, the additives are in a concentration of 0.5 to 10% w/w of the total master batch, more preferably found in a concentration of 1 to 3%.

When the micro or nanoparticles of metallic copper are included in this polymeric material in amounts of 1 to 25% of the weight of the polymer, this polymer takes antimicrobial characteristics, particularly virucides against COVID and human influenza viruses preferably, the masterbatch comprises 5-15% metallic copper particles, more preferably, comprises 8-12% copper particles, preferably 10%.

The present invention also relates to the preparation of a virucidal material containing a mixture of polymers, amines, additives and micro and nanoparticles of metals. Such a method allows obtaining a homogeneous mixture of the components at different concentrations, independent of the materials to be used, to obtain a desired matrix for different uses.

Such a method may be used in various materials, as a basis for obtaining a polymeric matrix which in turn may be implemented in materials such as polymers, surfaces for surfaces, coatings, paints, fabrics, papers, leather, or any material that provides the aforementioned materials.

Said method consists of the following steps: 1) pre-mixing, in this step the copper (nano and micro) particles are mixed with the additives, 2) drying, step wherein the premix is dried under oxygen absence conditions by preventing oxidation of the metal using a modified furnace to allow drying in the absence of oxygen; ?) preparation of the polymer matrix, wherein the dry premix is incorporated with the polymer to form a masterbatch, in the latter step processes such as dosing, extrusion, cutting, prilling, sorting, drying and packaging are used in the latter step.

The solution proposed in this invention comprises the use of polymers, amines, additives and metallic copper particles (nano and microparticles) which in combination allow for the manufacture of materials exhibiting virucidal activity. Analyses made to the part of the invention in virucidal activity assays deliver significant results in decreasing viral load, particularly in virucidal activity studies performed on MDCK cells which were infected with influenza virus (IAV) H1N1 pandemic 2009.

In addition, other assays demonstrate that when SARS-CoV-2 is exposed to polymeric materials having a treatment with nano and microparticles of metallic copper and specific additives according to the present invention, it causes degradation of the genetic material and capsid of the virus.

The inventors have also observed that the master batch with other metals exhibits virucidal activity. In one of the forms of the invention, the master batch may comprise other metal-like elements such as zinc and silver. In one of the forms of the invention, the masterbatch is composed of a polymeric material, metallic zinc particles and additives. In other of the forms of the invention, the master batch is composed of a polymeric material, metallic silver particles and additives. These master batches also present virucidal activity.

### Definitions

The definitions of the following scientific terms will now be presented which will allow for a further understanding of the invention.

When the term “masterbatch” is referred to herein as the term “masterbatch” is meant the entire mixture of pigment concentrate, colorant or additives dispersed within a plastic resin which exhibit specific characteristics.

The term “polymeric material” or “polymeric matrix” refers to any type of material comprising a polymer and a reinforcing material. The “polymer matrices” are characterized as being of low density, high corrosion resistance, low mechanical strength and cost and easy to manufacture.

The term “virucidal activity” refers to the entire agent, which may be a compound, a material, etc. that is capable of removing virus from a surface. In the case of this invention, the “virucidal activity” is given by the removal of the virus upon contact with a surface. When the term “antiviral” is used, it refers to a substance or medicament that is used for the treatment and removal of viruses.

When the term “virus” is indicated in the document, reference is made to a microscopic infectious agent that can only be reproduced within a cell of a different organism. Viruses are composed of nucleic acids (DNA or RNA) surrounded by proteins. When the term “capsid” or “nucleocapsid” is indicated to refer to a protein structure that coat the genetic material of the virus.

When the term “genetic material” is indicated to correspond to any material of animal, vegetable, or microbial origin containing the genetic information of said species and which can be transmitted to its offspring. The “genetic material” is composed of nucleic acids, a sugar molecule and a phosphate molecule and may be deoxyribonucleic (DNA) or ribonucleic (RNA). When the term “genome” is indicated in the document, the term “genome” and “genome integrity” corresponds to the conj of genetic material and the manner in which it can be kept stable to protect its genetic information respectively.

The term “viral load” corresponds to the quantification of a virus infection, which is estimated as the amount of virus present in a bodily fluid.

The term “synthetic samples” corresponds to a sample that has been generated in vitro and which serves to perform experiments as a control. This type of samples allow for the generation of data or information that can be contrasted with samples obtained from patients or the environment.

The term “RT-qPCR” refers to a molecular biology technique from the PCR technique. Conventional PCR or PCR consists of an in vitro enzymatic reaction that amplifies or increases a specific DNA sequence by generating millions of copies. The RT-qPCR technique has the same basis as conventional PCR, however, this first utilizes a called enzyme, a reverse transcriptase, which converts RNA from a virus into DNA, to then amplify this DNA into millions of copies. In addition, RT-qPCR is an assay that is performed in real time (qPCR), ie, it allows to quantify how much DNA fragment is occurring at that time in the sample by detecting a fluorescent signal. Other terms used herein refer to the “Ct cycles” or “Cq value”, this is part of the RT-qPCR technique and corresponds to the number of cycles in which the fluorescent signal is detected which then allows for the quantization. “probes or meters” correspond to specific small-sized DNA fragments used in the POR techniques which bind to a specific zone of the fragment that is desired to be amplified, with these being indicated to the enzyme the zones where it should proceed to the amplification.

### DESCRIPTION OF THE FIGURES

FIG. 1. Virucidal effect of polymeric materials. The virucidal effect of two polymeric materials can be seen in the figure. It is represented in the virucidal effect in percent of viral load decrease. Where ( [symbol] ) corresponds to the polymeric material used as a control comprising polymer and metallic copper, ( [symbol] ) corresponds to the polymeric material described herein.

FIG. 2. Counting viral genomes from SARS-CoV-2 synthetic samples for calibration curve. The amplification of the SARS-COV-2 nucleocapsid gene in the synthetic viral samples is presented in the graph. It can be seen that the amplification has a number of equivalent copies a range of I×l O4 and I×l O6. y=68, 87x^{˜}0′027 corresponds to the equation of the straight for this analysis.

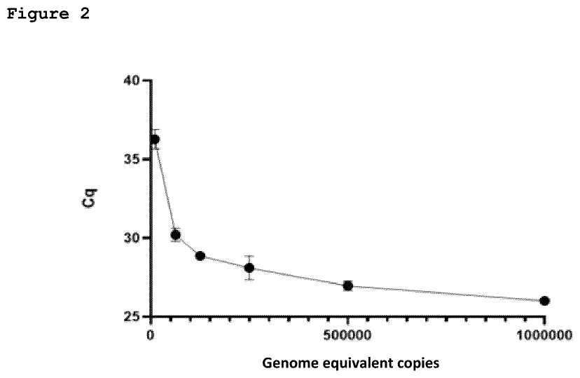

FIG. 3. Counting of SARS-CoV-2 viral genomes from patient samples. The number of viral genomes obtained after incubation of the viral sample in the PET polymer matrix is presented in the graph. Where, ( [symbol] ) indicates the incubation for 1 hour, ( [symbol] ) indicates incubation for 4 hours and ( [symbol] ) indicates incubation for 12 hours. All incubations were performed at room temperature.

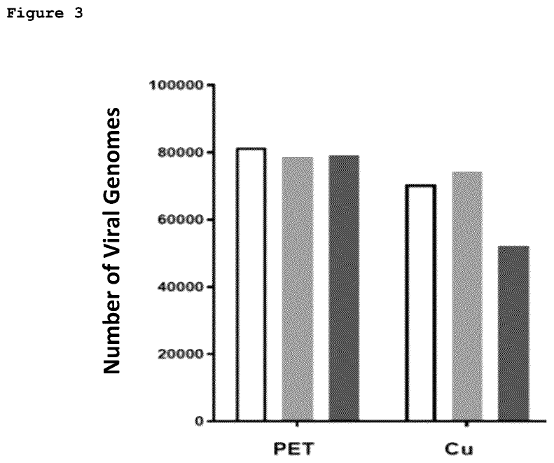

FIG. 4. Standardization of the damage produced by UV light in the genetic material of the virus. Figure (Cq) cycles of viral RNA exposed to UV light from 0 to 60 minutes are presented.

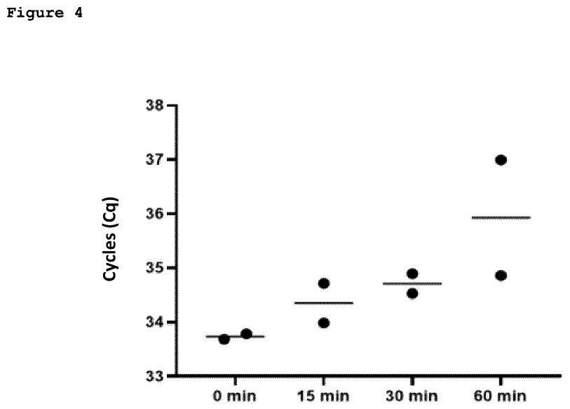

FIG. 5. Virucidal effect of PE and PET polymeric materials. The effect of polymer matrices copper SARS-CoV-2 samples is presented in the figure. It indicates the control of viral growth, PE_natural corresponds to PE without copper treatment, PET_virgin corresponds to PET without copper treatment, PE 9919-50% and PET_9927-50% correspond to PE and PET with 50% masterbatch, dotted lines indicate that there was no amplification of genetic material.

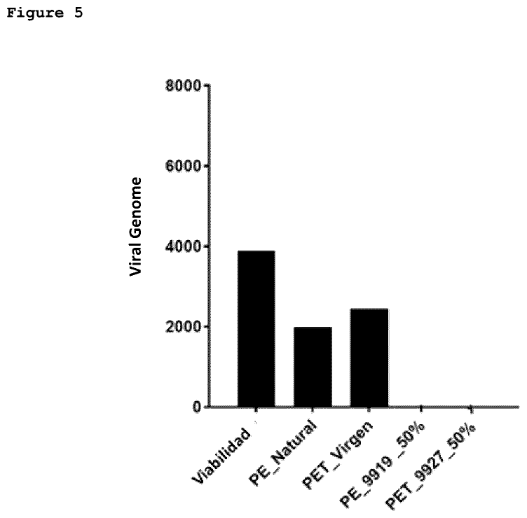

### EXAMPLES OF APPLICATION

### Example 1. Preparation of Polymeric Matrix with Virucidal Activity

This procedure is performed for obtaining a homogeneous polymeric matrix having virucidal activity.

The method for obtaining a virucidal polymeric matrix consists of the following steps:
1) Premix: At this stage the copper particles are mixed with the additives. Initially the metal is added with the additives, using a model TRR300 turbo mixer soft mix equipment, the initial mixture being performed at low speed in 3 cycles of 30 seconds, once this mixture is terminated, aqueous dispersion additives are added and mixed for 2 cycles of 90 seconds allowing excess additive and residual moisture to be removed. The additives should melt in a range of temperatures between 90 and 120° C. to achieve the additives to coat the metal particles.
2) drying: step wherein the premix is dried under oxygen absence conditions by preventing oxidation of the metal using a modified furnace to allow drying in the absence of oxygen. At this stage a modified furnace was used in the absence of oxygen; for this, oxygen from the nitrogen drying chamber is removed prior to entering the mixture for drying thereby eliminating residual moisture by maintaining the purity of the particulate metal so that it can react and release ions at their maximum capacity. This process is performed at atmospheric pressure, at a temperature ranging between 100° C. and 120° C. for a period ranging between 30 and 60 minutes, both of the above parameters being fixed according to the amount of additive and residual moisture present the mixture.
3) Preparation of the polymer matrix: where the dry premix is incorporated with the polymer to form a masterbatch in this latter step processes such as dosing, extrusion, cutting, prilling, sorting, drying and packaging are used. Particularly, an extrusion process is performed using a Coperion ZSK 18 extrusion equipment or the like with gravimetric dosing. In this process the masterbatch is produced The dosing system includes at least three gravimetric dosages with the possibility of entering the copper/additive mixture to the process, once the polymer is melted and in the zone designed for this purpose, with a geometry of spindles specifically designed for this purpose. The extrusion temperature ranges from 180° C. to 160° C. it is very important to work with vacuum system, with a minimum pressure of −0.8 bar, to ensure removal of volatiles and remaining impurities. For each polymer the temperatures vary and move in ranges between 20 to 30° C. over the polymer melt temperature. Finally, the material is dry cooled, to avoid the presence of moisture, for them a vented conveyor belt is used, then the material obtained is cut into a pelletizer. Said pellet-shaped material is dried again at 60° C. for 1 hour, to then be packaged. Such pellet-shaped material must be passed through its selection system, which ensures homogeneity of the pellets, by size selection, is then packaged in moisture and moisture barrier bags, which are hermetic and sealed.

### Example 2. Evaluation of Viral Activity of the Polymer Matrix on Influenza Virus

In this example of application, procedures performed for in vitro evaluation of the virucidal activity of the polymer matrix on influenza H1N1 virus, pandemic 2009 are described.

For this assay, 10 μL of a solution containing the H1N1 influenza virus was used that were placed on different materials to compare the virucidal effect, including the polymeric material described in this invention. The assay was incubated for a period of time of 1, 4 and 12 hours, to then recover the viruses and be deposited on an MDCK cell culture. The results of such an analysis indicate that by contacting the material described in this invention with the virus reduces the viral load by up to 98%, more specifically, the viral load decreases by 94% to the 1 hour incubation, in 96% after 4 hours of incubation, reaching a viral load decrease of 98% to 12 hours of incubation (Table 1).

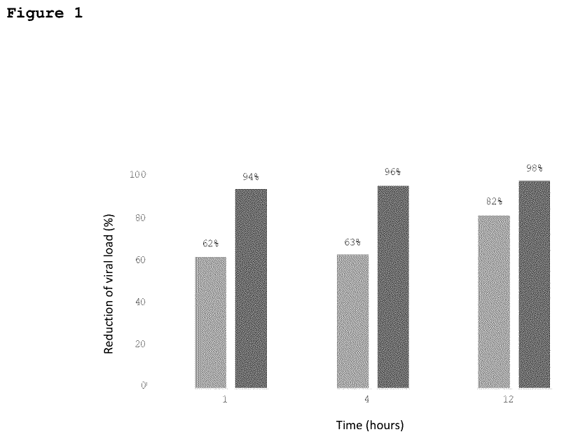

This assay was compared to another material used as a control, which comprises in its composition only polymer and metallic copper. The results obtained allow the polymeric material described in this invention to exhibit greater virucidal activity with respect to the control (FIG. 1, Table 1), where the latter reduced viral load to 82% over a period of 12 hours. Thus, the use of this material prepared with the polymer, amines, additives and copper metals is capable of significantly eliminating or decreasing the viral load that can be presented in this type of materials, which avoids the propagation and contact of this type of virus.

TABLE 1
Comparison of the decrease of viral load using different polymers.

| Time | | Título | Titulo | Reducción del |
|---|---|---|---|---|
| (hour) | Material | TCID50 | viral | título viral |
| 1 | C1 | 978053.7 | 1 × 10⁶ | |
| | M1 | 370084.6 | 4 × 10⁵ | 62% |
| | C2 | 97053.7 | 1 × 10⁶ | |
| | M2 | 56234.1 | 6 × 10⁴ | 94% |
| 4 | C1 | 562341.3 | 6 × 10⁵ | |
| | M1 | 208113.9 | 2 × 10⁵ | 63% |
| | C2 | 31622.8 | 3 × 10⁴ | |
| | M2 | 1389.1 | 1 × 10³ | 96% |
| 12 | C1 | 173925.3 | 2 × 10⁵ | |
| | M1 | 30928.8 | 3 × 10⁴ | 82% |
| | C2 | 173925.3 | 2 × 10⁵ | |
| | M2 | 4392.8 | 4 × 10³ | 98% |

The decrease in viral load using different polymers is presented in the table. C1 and C2 corresponds to the control material containing only polymer; MI corresponds to the polymer composite and metallic copper; M2 corresponds to the material described in this invention including metallic copper at a concentration of 10% and additives between 1 and 3%. the calculation for viral load reduction is performed using comparison between C1 and C2 with M1 and M2 respectively.

### Example 3 Evaluation of the Virucidal Activity of the Matrix or Polymeric Material on Coronavirus

In this example of application, procedures performed for in vitro evaluation of the virucidal activity of the polymeric material of the present invention are described on SARS-Cov-2 coronavirus samples. Particularly, in this example application a polymer matrix of PE (polyethylene) and PET (polyethylene terephthalate) was used.

### Preparation of Viral Samples and Incubation in Polymer Matrices.

Synthetic samples from viral solutions and nasopharyngeal samples obtained from patients counted with SARS-Cov-2 coronavirus were used for this assay.

The polymer matrices were cut with dimensions of 1.5 cm×1.5 cm and placed in 24-well plates. Each was added 300 μL of the virus sample and incubated for 2 hours at room temperature.

### Nucleic Acid Extraction.

After the incubation period of the polymer matrices, the samples were again incubated with a 1:1 volume of lysis buffer for 5 minutes, then this sample is incubated with 70% ethanol (1:1 ratio) and transferred to silica columns. RNA extraction was performed using the total RNA extraction kit from Omega Biotek to obtain total RNA according to manufacturer's instructions.

RT-qPCR.

After obtaining the viral RNA, a reverse transcriptase is performed. For amplification, One-step Fast Virus Kit (Thermo Fisher Scientific) and probe (s) that detect or amplify specific regions of the virus nucleocapsid gene (N gene) was used. In addition, a set of primers for human P RNAse gene detection and corresponding reaction controls were used.

The results show that the regions of the synthetic viral genome corresponding to the nucleocapsid in a range of equivalent copies between I×104 to I×l 06 (figure) was achieved. With these results a calibration curve was made in order to relate the results to the patient samples.

After obtaining the calibration curves, an assay was performed where the samples from patients were incubated on the PET polymer matrix, thus the matrix was used without copper treatment and a matrix with copper treatment and their corresponding additives (10% copper and 2% additives). These samples were incubated at 1, 4 and 12 hours. Equivalent genomes of genomes was performed by RT-qPCR (Figure). In these results it was observed that the copper-treated PET plastic exhibits a decrease effect on the copy number of the detected viral genome, with respect to the PET matrix found without the addition of copper.

To determine that the effect on decreasing the copy number of the virus genetic material is due to the action of copper polymer matrices and not by the action of other agents, such as UV light, an assay was performed where the samples were first exposed to UV light and then RT-qPCR. This is because the exposure of the virus to UV light at the time degrades the genomes that are free in the sample thereby serving to estimate the number of genome copies found in virus with intact capsids, therefore, when performing the RT-qPCR the higher integrity of the genome to be amplified is ensured. The results of this assay show that the UV has a dependent dose effect depending on the exposure time so that a suitable dose of UV can be established for the final assay on the polymer matrices (figure).

To determine the impact on the integrity of the virus genome of copper-treated plastics was evaluated by RT-qPCR the reduction in the number of viral RNA copies over time after a controlled and unique UV exposure. For this assay PE and PET was used without additives (or virgin), PE with 50% masterbatch (PE_9919-50%), PET with 50% masterbatch

(PET_9927-50%) where the incubation period was 2 hours at room temperature (Figure). The results of this analysis indicate that PE and PET materials corresponding to PET_9927-50% and PE_9918 50% decrease the viral load by 99% over a period of 2 hours. This was determined using the calibration curve and the results of the cycles (Ct) for each of the materials.

Therefore, assays demonstrate that there is a degradation of the genetic material of the virus and the capsid of the SARS-CoV-2 virus during the exposure of these polymeric materials presenting a treatment with nano and microparticles of metallic copper and specific additives.

### LITERATURE

Delgado M, Hernandez J. (2015). Los virus, ¿son organismos vivos? Discusión en la formación de profesores de Biología. VARONA, núm. 61, pp. 1-7
Johns Hopkins Medicine University. (2021). Coronavirus Resource Center. https://coronavirus.jhu.edu/map.html
Rijsbergen L, A van Dijk L, Engel M, D de Vries R, L de Swart R. (2021). In Vitro Modelling of Respiratory Virus Infections in Human Airway Epithelial Cells—A Systematic Review. Front Immunol 12:683002.
Minsal. Ministerio de Salud, Gobierno de Chile. (2021). Plan de acción coronavirus COVID-19, Información Oficial. https://www.gob.cl/coronavirus/
Minsal. Ministerio de Salud, Gobierno de Chile. (2020). Protocolo de limpieza y desinfección de ambientes COVID-19, excluye recintos de atención de salud. http://fedefruta.cl/wp-content/uploads/2020/03/PROTOCOLO-DE-LIMPIEZA-Y-DESINFECCION-DE-AMBIENTES-COVID-19.pdf
Grass G, Rensing C, Solioz M. (2011). Metallic Copper as an Antimicrobial Surface. Appl Environ Microbiol. 2011 March; 77(5): 1541-1547.
Noyce J O, Michel H, Keevil C W. (2007). Inactivation of influenza A virus on copper versus stainless steel surfaces. Appl. Environ. Microbiol. 73(8), 2748-2750.
Fujimori Y, Sato T, Hayata T. (2012). Novel antiviral characteristics of nanosized copper(I) iodide particles showing inactivation activity against 2009 pandemic H1N1 influenza virus. Appl. Envion. Microbiol. 78(4), 951-955.
Palza H, Quijada R, Delgado K. (2015). Antimicrobial polymer composites with copper micro and nanoparticles: Effect of particle size and polymer matrix. Journal of Bioactive and Compatible Polymers 1-15.

1. The invention relates to a master batch for preparing a material with antiviral and virucidal properties, characterized in that it comprises:
(i) a polymeric material selected from low density polyethylene (PE), high density polyethylene (HDPE), linear density polyethylene (LLDPE), polypropylene (PP), polyethylene terephthalate (PET), copolyester 5011 (modified PET or PETG), polycarbonate (PC), polymethylmethacrylate (PMMA), starch mixtures, polytrimethylene terephthalate (PTT), vinyl polychloride (PVC), polystyrene (PS), polybutylene terephthalate (PBAT), polycaprolactone (PCL) and polylactic acid (PLA), at a concentration of 65 and 98.5% w/w until 100% of the mixture is completed.
(ii) copper, zinc or metal silver particles at 1 to 25% w/w, wherein said particles have a purity of 99, 98 to 100%, without presenting oxygen or sulfides in their composition and present a size of 0, 1 to 100 microns.
(iii) Additives such as glycerol monostearate, glycerol ester, sorbitol ester, alcaloxylated ester, oleochemical derivatives, amines and their derivatives, wherein the amines are selected from ethoxylated amines, ethoxylated alkyl amines (C13 to C15 ethoxylated alkyl amine) at concentrations of 0.5 and 10% w/w of the total master batch.

2. A master batch for preparing a material with antiviral and virucidal properties according to claim 1 wherein the polymeric material is selected from polyethylene and polyethylene terephthalate.

3. A master batch for preparing a material with antiviral and virucidal properties according to claim 1 wherein the copper particles have a size of 0.3 to 40 microns.

4. A master batch for preparing a material with antiviral and virucidal properties according to claim 1 wherein the metallic copper particles are at a concentration of 5-15% w/w

5. A master batch for preparing a material with antiviral and virucidal properties according to claim 1 wherein the metallic copper particles are at a concentration of 10% w/w

6. A master batch for preparing a material with antiviral and virucidal properties according to claim 1 wherein the additives are in a concentration of 0.5 to 10%.

7. A master batch for preparing a material with antiviral and virucidal properties according to claim 1 wherein the additives are in a concentration of 1 to 3%.

8. Polymeric material with antiviral and virucidal properties characterized in that it is composed or made with the masterbatch described in claims 1 to 7.

9. Polymeric material with antiviral and virucidal properties characterized in that it is composed or made with the masterbatch described in claims 1 to 7 and is in the form of pellets, yarns, plates, blades, leaves or the other.

10. Use of the polymeric material with antiviral and virucidal properties according to claims 8 and 9 characterized in that it serves to form or make surfaces, containers of all types, garments, safety implements, fabrics, paints and coatings or others.

11. Use of the polymeric material with antiviral and virucidal properties according to claim 10 which serves to decrease the growth or presence of respiratory viruses.

12. Use of the polymeric material with antiviral and virucidal properties according to claims 10 and 11 characterized in that it serves to decrease the growth or presence of human influenza virus respiratory viruses and SARS-COV2.
